(19) United States
(12) Patent Application Publication
(10) Pub. No.: US 2023/0052643 A1
(43) Pub. Date: Feb. 16, 2023

(54) A STYRENE BUTADIENE POLYMER LATEX AND ITS APPLICATION THEREOF

(71) Applicant: BASF SE, Ludwigshafen am Rhein (DE)

(72) Inventors: Nan CHENG, Shanghai (CN); Titus David LEMAN, Shanghai (CN); Soehari LIONO, Hong Kong (CN); Nadaraja SUBRAMANIAM, Singapore (SG)

(21) Appl. No.: 17/789,544

(22) PCT Filed: Dec. 21, 2020
(86) PCT No.: PCT/EP2020/087398

§ 371 Date: Jun. 28, 2022

(30) Foreign Application Priority Data
Dec. 30, 2019 (CN) PCT/CN2019/129912

(51) Int. Cl. C08F 212/08

(52) U.S. Cl. CPC C08F 212/08

(57) ABSTRACT

The present invention is related to a carboxylated styrene butadiene polymer latex, a method for making such and its application as binders for paper coating. In particular, the latex shows excellent wet rub performance and peel off performance. The latex may find applications as binders for paper coating.

### FIELD OF INVENTION

The present invention is related to a styrene butadiene polymer latex, a method for making such and its application as binders for paper coating.

### BACKGROUND OF THE INVENTION

Water resistance is an important property of paper coating composition in offset printing and its application. The water resistance property is mostly endowed by the polymer latex. In offset printing, wetting water is always used. The strong physical mechanical forces exerted by printing machine may result in delamination of the pigment from the coating layer in the presence of water. Therefore, good water resistance is required. Wet adhesion is also an important criterion for paper coating composition in offset printing. Because it is desirable to have a clean printed appearance which can be achieved by preventing the pigment from peeling against strong physical forces on the surface of the pigment coating during printing. Various properties such as glass transition temperature, monomer composition, crosslinking density, etc. of the polymer latex for paper coatings composition can affect the wet adhesion of the composition.

W02002050128A1 discloses a method for preparing styrene-butadiene polymer latex comprising the step of emulsion polymerization by adding 0.1 to 10 parts by weight of chain transfer agent comprising: i) monofunctional thiol compound, and ii) polyfunctional thiol compound having at least two thiol groups based on 100 parts by weight of styrene-butadiene monomer composition. The polymer latex prepared by the method can result in a polymer latex with improved adhesion while maintaining various printing properties. However, the polymer latex does not show any improved water resistance properties.

W02007033929A1 discloses an aqueous dispersion of a polymer obtainable by emulsion-polymerizing free-radically unsaturated compounds (monomers) in the presence of at least two different polymerization regulators A) and B), characterized in that A) is a compound selected from α-methylstyrene dimer and hydrocarbons which on abstraction of a hydrogen atom form a pentadienyl or 1-phenylallyl radical and B) is a compound having a mercapto group, the amount of B) being more than 2 parts by weight per 100 parts by weight of monomers. The resulted paper coating slips have high binding power in combination with a high degree of freedom from blisters. However, no information regarding the water resistance performance or wet adhesion is disclosed.

However, there is no prior arts that discloses a styrene butadiene polymer latex that shows both excellent water resistance and wet adhesion properties.

### SUMMARY

One objective of the present invention is to provide a styrene butadiene polymer latex that shows both excellent water resistance and wet adhesion properties. The polymer latex is synthesized with a monomer composition comprising;
a) styrene,
b) hydrocarbons having 2 to 8 carbon atoms and two or more olefinic double bonds,
c) at least one hydrophobic acrylate,
d) at least one monoethylenically unsaturated hydrophilic monomer,
e) at least one monoethylenically unsaturated monomer containing at least two hydrophilic groups or at least one anhydride;

wherein the polymer latex is obtainable by emulsion-polymerizing free-radically unsaturated compounds (monomers) in the presence of at least two different polymerization regulators I) and II), characterized in that I) is a compound selected from α-methylstyrene dimer and hydrocarbons which on abstraction of a hydrogen atom form a pentadienyl or 1-phenylallyl radical and II) is a compound having a mercapto group.

Another objective of the present invention is to provide a method for making such styrene butadiene polymer latex. The polymer latex is synthesized by step feeding process.

A third objective of the present invention is about the application of the styrene butadiene polymer latex as binders for paper coatings.

### DETAILED DESCRIPTION OF THE PRESENT INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The designation (meth)acrylate and similar designations are used herein as an abbreviated notation for “acrylate and/or methacrylate”.

The glass transition temperature Tg means the temperature at the inflection point (“midpoint temperature”) determined in accordance with ISO 11357-2:2013 by differential scanning calorimetry (DSC).

Crosslinking density means the crosslinking state of polymers measured by NMR relaxation times of the mobile protons with a unit of millisecond (ms), the so-called T₂ time.

Step feeding means the reaction mixture is fed into the reactor in a staged or gradient procedure.

All percentages and ratios denote weight percentages and weight ratios unless otherwise specified.

The present invention relates to a polymer latex that is synthesized with a monomer composition comprising;
a) styrene or its derivative,
b) hydrocarbons having 2 to 8 carbon atoms and two or more olefinic double bonds,
c) at least one hydrophobic acrylate,
d) at least one monoethylenically unsaturated hydrophilic monomer,
e) at least one monoethylenically unsaturated monomer containing at least two hydrophilic groups or at least one anhydride;
wherein the polymer latex is obtainable by emulsion-polymerizing free-radically unsaturated compounds (monomers) in the presence of at least two different polymerization regulators I) and II), characterized in that I) is a compound selected from α-methylstyrene dimer and hydrocarbons which on abstraction of a hydrogen atom form a pentadienyl or 1-phenylallyl radical and II) is a compound having a mercapto group.

The styrene and its derivative (monomer a)) may be unsubstituted styrene or C1-C6-alkyl substituted styrenes, for example, but not limited to, styrene, α-methylstyrene, ortho-, meta- and para-methylstyrene, ortho-, meta- and para-ethylstyrene, o,p-dimethylstyrene, o, p-diethylstyrene, ispropylstyrene, o-methyl-p-isopropylstyrene or any mixture thereof. In one embodiment, styrene is a preferred compound for monomer a).

The hydrocarbons having 2 to 8 carbon atoms and two or more olefinic double bonds (monomer b)) may include, but not limited to, conjugated dienes and nonconjugated dienes. For example, such dienes may be selected from butadiene, isoprene, 3,5-octadiene, 2,5-heptadiene, 1,5-hexadiene, etc. In one embodiment, butadiene is a preferred compound for monomer b).

The at least one hydrophobic acrylate (monomer c)) includes, but not limited to, C1-C19-alkyl (meth)acrylates, such as, methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate (i.e. lauryl (meth)acrylate), tetradecyl (meth)acrylate, oleyl (meth)acrylate, palmityl (meth)acrylate, stearyl (meth)acrylate, isobornyl (meth)acrylate, benzyl (meth)acrylate, phenyl (meth)acrylate and a mixture thereof. In one embodiment, one or more C1-C12-alkyl (meth)acrylates, such as methyl (meth)acrylate, ethyl (meth)acrylate, n-butyl (meth)acrylate and 2-ethylhexyl (meth)acrylate a mixture thereof is chosen as the at least one hydrophobic acrylate for monomer c).

The at least one monoethylenically unsaturated hydrophilic monomer (monomer d)) may be monoethylenically unsaturated monomers containing at least one functional group selected from the group consisting of carboxylic acid, sulfonic acid, phosphoric acid, hydroxyl and amide. Particularly at least one monoethylenically unsaturated hydrophilic monomer includes, but is not limited to, monoethylenically unsaturated carboxylic acids, such as (meth)acrylic acid and cinnamic acid; monoethylenically unsaturated amides, especially N-alkylolamides, such as (meth)acrylamide, N-methylol (meth)acrylamide, 2-hydroxyethyl (meth)acrylamide; and hydroxyalkyl esters of monoethylenically unsaturated carboxylic acids, such as hydroxyethyl (meth)acrylate and hydroxypropyl (meth)acrylate. In one embodiment, acrylic acid and/or (meth)acrylic acid is the preferred monomer d).

The at least one monoethylenically unsaturated monomer containing at least two hydrophilic groups or at least one anhydride (monomer e)) may include, but not limited to, itaconic acid, fumaric acid, glutaconic acid, maleic acid, traumatic acid, citraconic acid, mesaconic acid, aconitic acid, itaconic acid anhydride, fumaric acid anhydride, cinnamic acid anhydride, glutaconic acid anhydride and maleic acid anhydride. In one embodiment, itaconic acid, fumaric acid, glutaconic acid and maleic acid is the preferred monomer e).

The total amount of monomer a), b) & c) may be in an amount of at least 80 wt %, preferably at least 85 wt %, more preferably at least 90 wt %, and mostly preferably at least 95 wt %, all based on the total weight of the monomers for the polymer latex. The total amount of monomer d) and e) may be in an amount of at least 0.1 wt % and no more than 20 wt %, preferably no more than 15 wt %, more preferably no more than 10 wt %, and mostly preferably no more than 5 wt %, all based on the total weight of the monomers for the polymer latex. In a preferred embodiment, the monomer c) may be presented in an amount of 0.1 to 20 wt %, preferably in an amount of 0.5 to 15 wt %, and more preferably in an amount of 1 to 10 wt %, and most preferably in an amount of 2 to 5 wt %, based on the total weight of the monomers for the polymer latex.

The monomers for the present invention may further comprise one or more crosslinking monomers. The crosslinking monomers can be chosen from di- or poly-isocyanates, polyaziridines, polycarbodiimide, polyoxazolines, glyoxals, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol(meth)acrylamide, (isobutoxymethyl)acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl)trimethoxysilane and (3-methacryloxypropyl)trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof. In one embodiment, glycidyl (meth)acrylate is the preferred crosslinking monomer.

The crosslinker can be added in an amount of no more than 10% by weight, preferably no more than 8% by weight, more preferably no more than 5% by weight, based on the total weight of the all monomers used for the of polymer latex.

Many other polymerizable monomers may also be added into the polymerization, such as vinyl esters, (meth)acrylonitrile monomers, and monoethylenically unsaturated di- and tricarboxylic esters. Examples of such polymerizable monomers include, but not limited to, vinyl acetate, vinyl propionate, vinyl butanoate, vinyl valerate, vinyl hexanoate, vinyl versitate, acrylonitrile, diethyl maleate, dimethyl fumarate, ethyl methyl itaconate, dihexyl succinate, didecyl succinate or any mixture thereof.

The glass transition temperature (Tg) of the polymer according to the present invention may be in the range of −30 to +30° C., preferably in the range of −20 to +20° C., and more preferably in the range of −10 to +10° C. The Tg of a polymer can be managed via varying the weight ratio of different monomers. For example, in the present invention, the addition of more methyl methacrylate monomers may increase the Tg while the addition of more n-butyl acrylate may decrease the Tg.

The crosslinking density of the polymer is in the range of 2 to 7 ms, preferably in the range of 2.5 to 7 ms, more preferably in the range of 2.5 to 6.5 ms and most preferably in the range of 3 to 6 ms.

The dispersion by emulsion polymerization is effected according to the invention in the presence of at least two different polymerization regulators I) and II).

Regulator I) is selected from a group of hydrocarbon compounds comprising: α-methylstyrene dimer and/or compounds which form a pentadienyl or 1-phenylallyl radical on abstraction of a hydrogen atom. These are compounds which have either a 1,4-pentadiene structure of the formula A1) with one or two hydrogen atoms on the C3 atom (middle carbon atom in the formula below)

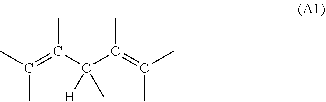

or a 1,3-pentadiene structure of the formula A2) with one or two hydrogen atoms on the C5 atom (last carbon atom in the formula below)

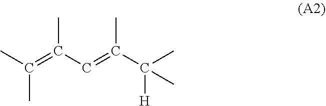

it being possible for one of the double bonds also to be part of a phenyl ring. In the structures A1 and A2, the perpendicular lines indicate unsaturated valencies, but without specifying the stereochemistry of the double bonds. The unsaturated valencies may be saturated with hydrogen, an alkyl group or a phenyl group, or two unsaturated valencies in each case may form a 5- or a 6-membered carbocycle. Valencies at two carbon atoms bonded to one another via a double bond, together with the carbon atoms of the double bond, may represent a phenyl ring.

Examples of compounds of the formula A1) are 1,4-dihydrobenzene, γ-terpinene, terpinolene and norbornadiene α-ionone. Examples of compounds of the formula A2) are 1,3-cyclohexadiene, α-terpinene and α-phellandrene.

Preferred compounds I) are compounds of the formula A1). Terpinolene (4-(2-propylidene)-1-methylcyclohex-1-ene) is particularly preferred. Terpinolene has the formula:

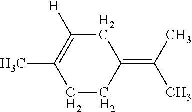

The amount of the regulator I) is preferably from 0.01 to 5 parts by weight, preferably from 0.02 to 2 parts and more preferably 0.05 to 0.4 parts, based on 100 parts by weight of monomers used for polymer latex.

In particular, the content of the regulator I) is from 0.02 to 0.7 and, in a particularly preferred embodiment, from 0.1 to 0.4 part by weight, based on 100 parts by weight of monomers used for polymer latex.

Regulator II) is a compound having a mercapto group (SH group). Apart from the SH group, preferred regulators II) comprise only carbon and hydrogen atoms. C4-C18-alkyl mercaptans, such as n-hexyl mercaptan, n-octyl mercaptan, tert-octyl mercaptan, n-decyl mercaptan, n-dodecyl mercaptan, tert-dodecyl mercaptan, n-hexadecyl mercaptan and stearyl mercaptan, may be mentioned as suitable compounds II).

Tert-Dodecyl mercaptan is particularly preferred.

The amount of the polymerization regulator II) is 2 to 5 parts by weight, preferably from 2.1 to 4 and more preferably from 2.15 to 3 parts by weight, based on 100 parts by weight of monomers used for polymer latex.

The preparation of the polymers is prepared in a preferred embodiment by emulsion polymerization, and the polymer is therefore an emulsion polymer.

The emulsion polymerization may be carried out in the presence of various common initiating systems, including but not limited to a thermal or redox initiator. The initiator is usually used in an amount of no more than 10% by weight, preferably 0.02 to 5% by weight, more preferably 0.1 to 1.5 wt %, based on the total weight of the two stage monomers.

Thermal initiators, such as peroxides, persulfates and azo compounds, are generally used. Peroxides, which may be used include, but are not limited to, inorganic peroxides, such as hydrogen peroxide, or peroxodisulfates, or organic peroxides, such as tert-butyl, p-menthyl or cumyl hydroperoxide, tert-butyl perpivalate, and dialkyl or diaryl peroxides, such as di-tert-butyl or di-cumyl peroxide. Azo compounds which may be used, include, but not limited to, 2,2″-azobis(isobutyronitrile), 2,2″-azobis(2,4-dimethylvaleronitrile). Among others, sodium persulfate (SPS), potassium persulfate (KPS), ammonium persulfate (APS), 2,2″-azobis(amidinopropyl) dihydrochloride (AIBA, V-50 TM), and 4,4′-azobis(4-cyanovaleric acid) (ACVA, V501) are preferred as the thermal initiator.

A redox initiator usually comprises an oxidizing agent and a reducing agent. Suitable oxidizing agents include the abovementioned peroxides. Suitable reducing agents may be alkali metal sulfites, such as potassium and/or sodium sulfite, or alkali metal hydrogensulfites, such as potassium and/or sodium hydrogensulfite. Preferable redox initiators include an oxidizing agent selected from the group consisting of t-butylhydroperoxide and hydrogen peroxide, and a reducing agent selected from ascorbic acid, sodium formaldehyde sulfoxylate, sodium acetone bisulfite and sodium metabisulfite (sodium disulfite).

In an emulsion polymerization process, most surfactants known to the skilled person in the art may be used. Surfactant to be used according to the present invention may be a non-reactive surfactant, a reactive surfactant or a combination thereof. Surfactants may be formulated together with the monomers and fed into a reaction reactor. Alternatively, the surfactants may be added into the reaction medium first followed by the feeding of monomers. Surfactants may be used in a suitable amount known to the skilled person in the art, for example, in a total amount of 0.1% to 6% by weight, based on the total weight of the monomers.

Surfactants may be non-reactive anionic and/or nonionic surfactants. Suitable non-reactive anionic surfactants, for example, include, but are not limited to, alkyl, aryl or alkylaryl sulfate salts, sulfonate salts or phosphate salts; alkyl sulfonic acids; sulfosuccinate salts; fatty alcohol ether sulfate salts and fatty acids. Suitable non-reactive nonionic surfactants for example include alcohol or phenol ethoxylates such as polyoxyethylene alkylphenyl ether.

Surfactants may also be polymerizable surfactants, also called reactive surfactants, containing at least one ethylenically unsaturated functional group. Suitable polymerizable surfactants for example include, but are not limited to, allyl polyoxyalkylene ether sulfate salts such as sodium salts of allyl polyoxyethylene alkyl ether sulfate, allyl alkyl succinate sulfonate salts, allyl ether hydroxyl propanesulfonate salts such as sodium salts, polyoxyethylene styrenated phenyl ether sulfate salts such as ammonium salts, for example DKS Hitenol® AR 1025 and DKS Hitenol® AR 2020, polyoxyethylene alkylphenyl ether sulfate ammonium salts, polyoxyethylene allyloxy nonylphenoxypropyl ether, and phosphate acrylates such as SIPOMER® PAM 100, phosphate acrylates such as SIPOMER® PAM 200, etc. Other suitable reactive surfactants also include Adeka Reasoap ER/SR series and Lutensol TO types.

It's also an option to add at least two kinds of surfactant into the system. In a preferred embodiment, a combination of reactive surfactant and non-reactive surfactant can be used. The weight ratio of the reactive surfactant and non-reactive surfactant may be in range of 1:10 to 10:1, preferably in the range of 1:5 to 5:1 and most preferably in the range of 1:2 to 2:1.

The manner in which the polymerization regulators are added to the polymerization vessel in the course of the aqueous emulsion polymerization is known to the skilled person in the art. They may be initially put into the polymerization vessel or fed in during the polymerization, for example continuously or in individual portions; a combination of these measures is also possible.

The emulsion polymerization may be conducted either as a batch operation or in the form of a step feed process (i.e. the reaction mixture is fed into the reactor in a staged or gradient procedure). Feed process is a preferred process. In such a process, a portion of the reaction mixture may be introduced as an initial charge and heated to the polymerization temperature. Then the remainder of the polymerization mixture is supplied to the reactor, usually by way of two or more spatially separate feed streams. After the completion of the feeding, the reaction is further carried out for another 10 to 30 min and, optionally, followed by complete or partial neutralization of the mixture. Upon the completion of the feeding, the polymerization is kept for another 30 to 90 min. Afterwards, the reaction mixture may be subject to oxidants, neutralizing agents, etc.

The different monomers may be added into the reactor simultaneously or following different feeding orders. In a preferred embodiment, the acrylate monomers are fed into the reactor after the completion of the feeding of other monomers.

The polymer or the aqueous dispersion of the polymer is particularly suitable as a binder in paper coating slips.

Paper coating slips which comprise pigments are particularly suitable.

The paper coating slips comprise in particular white pigments, such as barium sulfate, calcium carbonate, calcium sulfoaluminate, kaolin, talc, titanium dioxide, chalk or coating clay; organic pigments, e.g. luster pigments, may also be present.

The paper coating slips comprise the above polymer, in particular in amounts of from 1 to 50 parts by weight (solid, without water), particularly preferably from 2 to 30 parts by weight and very particularly preferably from 3 to 20 parts by weight per 100 parts by weight of pigment.

In addition to the polymer and pigment, the paper coating slip may comprise further constituents.

Optical brighteners, leveling agents, rheology additives, e.g. thickeners, dispersants, emulsifiers and stabilizers may be mentioned by way of example.

The solids content of the paper coating slip is preferably from 30 to 80% by weight, in particular from 40 to 75% by weight, particularly preferably from 50 to 75% by weight.

The paper coating slip can be applied as a coat to paper or cardboard by conventional methods.

A particularly suitable substrate to be coated is base paper or cardboard, precoated papers or cardboard or surface-treated (smoothed, e.g. by calendering) papers or cardboard.

A suitable application method is, for example, the blade method (doctor blade), film press method or curtain coating method.

After the coating, drying is applied in order to remove the water.

The coat weight of the paper coating slip on the substrate to be coated (dry, without water) is preferably from 0.1 to 200 g/m2, particularly preferably from 0.1 to 50 g/m2.

The coatings obtained are very uniform and exhibit no defects or scarcely any defects.

High coating speeds are possible.

### EXAMPLES

The present invention is further demonstrated and exemplified in the Examples, however, without being limited to the embodiments described in the Examples.

Description of commercially available materials used in the following Examples:

Dowfax® 2A1, anionic surfactant, Alkyldiphenyloxide Disulfonate, from Dow.

Triton® B Powder (White Powder, Molar mass 380 g/mol, Bulk Density:650 g/1), chelating agent, ethylenediaminetetraacetic acid and its sodium and ammonium salts, from BASF.

Foamaster®WO 2360: White Oil defoamer for physical stripping supplied by BASF.

Acticide® MV, biocide, mixture of 5-chloro-2-methyl-4-isothiazolin-3-one (1.11%) and 2-methyl-4-isothiazolin-3-one (0.37%), from THOR.

All experiments described hereinafter were performed at a temperature of 20° C. unless otherwise specified.

The crosslinking density (T₂ time) is determined by measuring the NMR relaxation of a specimen of the base dispersion from which water has been removed and which has been converted into a film. For this, the specimen is, for example, dried in air overnight, at 60° C. for 3 h in vacuo and then studied at 80° C., using a suitable measuring apparatus, e.g. Bruker minispec (Bruker, USA). Measurement and evaluation of T₂ determination are known in the art. In the examples, a method was used in the Andrei et al., AdvPol. Sci. 69. (1989) was applied.

The particle size as referred herein relates to the Z average particle diameter as determined by means dynamic light scattering (DLS). The measurement method is described in the ISO 13321:1996 standard. For this purpose, a sample of the aqueous polymer latex will be diluted and the dilution will be analyzed. In the context of DLS, the aqueous dilution may have a polymer concentration in the range from 0.001 to 0.5% by weight, depending on the particle size. For most cases, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a nonionic emulsifier, e.g. an ethoxylated C16/C18 alkanol (degree of ethoxylation of 18), as a diluent. Measurement configuration: HPPS from Malvern, automated, with continuous-flow cuvette and Gilson autosampler.

Parameters: measurement temperature 20.0° C.; measurement time 120 seconds (6 cycles each of 20 s); scattering angle 173°; wavelength laser 633 nm (HeNe); refractive index of medium 1 .332 (aqueous); viscosity 0.9546 mPa-s. The measurement gives an average value of the second order cumulant analysis (mean of fits), i.e. Z average. The “mean of fits” is an average, intensity-weighted hydrodynamic particle diameter in nm.

Chemical Stability

Good chemical stability is important in paper coating as it provides excellent rheology and machine runnability for the calcium carbonate containing coating formulation.

The dispersion sample was filtered through a 325 meshes strainer. Then, M grams (about 50 g) of the filtered sample was put into a 150 ml beaker on electromagnetically heated agitator. The filtered sample was stirred at 45±2° C. and 10 ml calcium chloride solution (1 wt %) was added into the beaker over 2 minutes. After the addition of calcium chloride, the filtered sample was further stirred for another 2 minutes.

The calcium containing filtered sample was pass through M2 grams dried 325 mesh sieve. Then, the sieve was rinsed with DI water continuously until the filtrate does not show any milky sign. The sieve was further dried in an oven at 140° C. for 30 min. After the sieves were cooled down to room temperature, the mass of the sieve was weighted and recorded as M₁.

The chemical stability is defined as:

$$X \% = \frac{{M}_{1} - {M}_{2}}{M} \times 100 \%$$

### SYNTHESIS EXAMPLES

### Example 1

Feed 1 was prepared by mixing 480 g water, 40 g Dowfax 2A1, 143 g itaconic acid solution (IA, 7 wt %) and 46 g acrylic acid (AA, 100%). Feed 2 was prepared by mixing 1000 g styrene and 18 g t-dodecylmercaptane. Feed 3 is 874 g butadiene.

The reactor was evacuated and then filled with N₂. The reactor was loaded with 10 g Triton® B, 142.8 g itaconic acid solution (7 wt %), 4.4 g Dowfax 2A1 solution, 39.4 g seed dispersion (Pre-product 6772, a polystyrene seed with a diameter of 30 nm, 33 wt % solid content, from BASF), 2.44 g Terpinolene (90 wt % solution) and 500 g water and the mixture was stirred at a speed of 200 rpm. Then, the mixture was heated up to. When the temperature reached 85° C., 32.6 g Feed1, 33.6 g Feed2 and 24.6 g Feed3 were charged into the reactor, followed by 28.57 g ammonium persulfate (%). The polymerization went on for 5 min. When the temperature reached 90° C., the rest of the feeds were fed into the reactor via dynamic mixer. In detail, the feeding of feed 1 was finished in 4 hours 30 mins while feed 2 and 3 were finished in 3 hours 30 mins. Simultaneously, 271.43 g ammonium persulfate (7 wt % solution) was fed into the reactor over 4 hour 45 min. Immediately after the completion of the feeding of feed 2 and feed 3, 60 g methyl methacrylate was fed into the reactor over 1 hour. In addition, after the feeding of each feed, 20 g of water was used to rinse the feeding line.

After the completion of ammonium persulfate feed, the polymerization continued for another 15 min at 85° C. Afterwards, the feeding line was rinsed was 70 g water. Then 120 g NaOH solution (10 wt %) was added into the reactor in 30 min, followed by the addition of 42 g t-butyl hydroperoxide solution (10 wt %) and 50.15 g acetonbisulfite solution (13 wt %) is added into the reactor over 90 min at 80° C. After the completion of the addition, the mixture was further stirred for another 30 min.

The mixture was cooled down to room temperature. Then, 0.8 g Foamaster WO 2360 was added into the mixture and the pH of the mixture was adjusted to 6-7 with NaOH. Last, 12.4 g Acticid MV was added into the mixture to obtain the final polymer latex. The final polymer latex has a Tg of −5° C., a crosslinking density of 4.8 ms, solid content of 50% and particle size of 160 nm and chemical stability is ca. 0.0113%.

### Example 2

The latex was prepared in the same way as described for Example 1, except that the 60 g methyl methacrylate was replaced with 60 g of n-butyl acrylate. The final polymer latex has a Tg of +7° C., a crosslinking density of 3.7 ms, a solid content of 52.8% and particle size of 160.2 nm.

### Example 3

The latex was prepared in the same way as described for Example 1, except that the 60 g methyl methacrylate was replaced with 60 g of butyl methacrylate. The final polymer latex has a Tg of −3° C., a crosslinking density of 3.4 ms, a solid content of 50.9% and particle size of 161.1 nm.

### Example 4

The latex was prepared in the same way as described for Example 3, except that an additional 10 g of glycidyl methacrylate was added together with butyl methacrylate. The final polymer latex has a Tg of −5° C., a crosslinking density of 3.8 ms, a solid content of 52% and particle size of 162 nm.

### Example 5

The latex was prepared in the same way as described for Example 2, except that the amount of styrene was decreased to 965 g, the amount of n-butyl acrylate was increased to 90 g and the amount of butadiene was increased to 879 g. The final polymer latex has a Tg of −6° C., a crosslinking density of 4.3 ms, a solid content of 52.2% and particle size of 159 nm.

### Example 6

The latex was prepared in the same way as described for Example 2, except that 90 g of n-butyl acrylate was replaced with 90 g of ethylhexyl acrylate. The final polymer latex has a Tg of −2° C., a crosslinking density of 5.3 ms, a solid content of 50.5% and particle size of 161.7 nm.

### Example 7

The latex was prepared in the same way as described for Example 1, except that 40 g Dowfax 2A1 was replaced by the combination of 26.7 g Dowfax 2A-1 and 27.3 g Disponil FES 993. The final polymer latex has a Tg of −3.2° C., a crosslinking density of 4.3 ms, a solid content of 50.1% and particle size of 162.1 nm. The chemical stability is ca. 0.003%.

### Example 8

The latex was prepared in the same way as described for Example 1, except that 40 g Dowfax 2A1 was replaced by 63.12 gr SR10-25. The final polymer latex has a Tg of −2.8° C., a crosslinking density of 4.2 ms, a solid content of 52.1% and particle size of 160.2 nm. The chemical stability is ca. 0.004%.

### Comparative Example 1

The latex was prepared in the same way as described for Example 5, except that no Terpinolene was added into the reaction mixture. The final polymer latex has a Tg of −5° C., a crosslinking density of 4.0 ms, a solid content of 51.2% and particle size of 164.3 nm.

### Comparative Example 2

The latex was prepared in the same way as described for Example 3, except that no itaconic acid was added into the reaction mixture. The final polymer latex has a Tg of −4° C., a crosslinking density of 3.8 ms, a solid content of 53% and particle size of 165.4 nm.

Production of the Coated Paper:

Both sides of a Sappi wood-free precoat paper (with a weight of 80 g/m²) were coated with a top coat composition using laboratory coating machine. After each coating cycle, the coated paper was dried using an IR lamp. For each coating cycle, 10 g/m² of top coat was coated onto each side of the precoat paper (i.e. for each finished coating cycle, there was 10 g/m² of top coat on each side of the paper). And, two cycles in total were performed on the precoat paper. The weight of the finally coated paper test paper was 120 g/m². The paper was passed four times through a laboratory calendar (one pair of rolls, nip pressure: 2000 N/cm) before the testing of the performance characteristics.

The composition for the top coat was formulated as follows:
90 parts by weight of calcium carbonate (Hydrocarb 95 from Omya, Oftringen, Switzerland)
10 parts by weight of Kaolin (Amazon Premium from Kaolin International)
0.1 part by weight of polyacrylic acid (Sokalan PA 30 from BASF SE, Ludwigshafen, Germany)
20 part by weight of the polymer latex as prepared above (50% strength by weight, corresponding to 10 parts by weight of polymer)
0.3 parts by weight Lubricant
0.18 part by weight of thickener (Sterocoll FS from BASF SE, Ludwigshafen, Germany)

The solids content for the top coat composition was adjusted to 65% with DI. water. The pH of the top coat composition was adjusted to 8.5 by adding 10% strength by weight NaOH solution.

Taber Wet Abrasion (Wet Rub)

The Taber wet abrasion was subsequently determined on the coated paper. The Taber wet abrasion was carried out according to amended French Standard Q 03-055, with annular test specimens with outer and inner diameters of 110 and 8 mm respectively, with 10 revolutions, CS O wheels, under a pressure of 1 N, in the presence of 2 ml of water, followed by rinsing with 10 ml of water; these 12 ml of water are collected and made up to 500 ml with water and then the turbidity of these 500 ml of water is determined with a Hach turbidimeter. The turbidity found is expressed in NTU units (the lower the turbidity values, the better the wet abrasion resistance of the coating). Three pieces of coated paper were prepared for each latex and a Taber wet abrasion test was performed on each piece of coated paper. The number average NTU units of the three tests for each latex was recorded as the final result.

Peel Off Test
1. Prepare 3 pieces of coated paper for each polymer latex.
2. Put a piece of the coated paper immersed under water inside the bucket.
3. Then, start to rub gently using the finger on the test specimen with a constant force of about 7 N and start recording the time.
4. As soon as the coating layer peels off from the surface of the test specimen, stop rubbing and record the final time.
5. Calculate the number average time of the three tests of each polymer latex.

TABLE 1

| | Wet Rub | Peel off | Chain Transfer | Acid |
|---|---|---|---|---|
| | (NTU) | (s) | Agent | Monomer |
| Example 1 | 38 | 30 | TDMC & | IA & AA |
| | | | Terpinolene | |
| Example 2 | 30 | 35 | TDMC & | IA & AA |
| | | | Terpinolene | |
| Example 3 | 42 | 30 | TDMC & | IA & AA |
| | | | Terpinolene | |
| Example 4 | 36 | 34 | TDMC & | IA & AA |
| | | | Terpinolene | |
| Example 5 | 40 | 30 | TDMC & | IA & AA |
| | | | Terpinolene | |
| Example 6 | 35 | 38 | TDMC & | IA & AA |
| | | | Terpinolene | |
| Example 7 | 43 | 30 | TDMC & | IA & AA |
| | | | Terpinolene | |
| Example 8 | 32 | 36 | TDMC & | IA & AA |
| | | | Terpinolene | |
| Com. Exp 1 | 128 | 15 | TDMC only | IA & AA |
| Com. Exp 2 | 61 | 13 | TDMC & | AA only |
| | | | Terpinolene | |

It's obvious that all the examples show excellent wet rub performance (low NTU value) and peel off performance (longer peel off record) (i.e. they have outstanding water resistance). Comparative examples show worse wet rub and peel off performance, due to the missing of either terpinolene or acrylic acid. In addition, the presence of reactive surfactant can further help improve the chemical stability.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

1.-14. (canceled)

15. A polymer latex contains a polymer that is synthesized with a monomer composition comprising:
a) styrene or its derivative,
b) hydrocarbons having 2 to 8 carbon atoms and two or more olefinic double bonds,
c) at least one hydrophobic acrylate,
d) at least one monoethylenically unsaturated hydrophilic monomer,
e) at least one monoethylenically unsaturated monomer containing at least two hydrophilic groups or at least one anhydride;
wherein the polymer latex is obtained by emulsion-polymerizing free-radically unsaturated compounds (monomers) in the presence of at least two different polymerization regulators I) and II), characterized in that I) is a compound selected from α-methylstyrene dimer and hydrocarbons which on abstraction of a hydrogen atom form a pentadienyl or 1-phenylallyl radical and II) is a compound having a mercapto group.

16. A polymer latex according to claim 15, wherein the total amount of monomer a), b) & c) may be in an amount of at least 80 wt % based on the total weight of the monomers for the polymer latex.

17. A polymer latex according to claim 15, wherein the monomer c) may be presented in an amount of 0.1 to 20 wt % based on the total weight of the monomers for the polymer latex.

18. A polymer latex according to claim 15, wherein total amount of monomer d) and e) may be in an amount of at least 0.1 wt % and no more than 20 wt % based on the total weight of the monomers for the polymer latex.

19. A polymer latex according to claim 15, wherein the glass transition temperature of the polymer is in the range of −30 to +30° C.

20. A polymer latex according to claim 15, wherein the crosslinking density (T₂) of the polymer is in the range of 2 to 7 ms.

21. A polymer latex according to claim 15, wherein the regulator I) are an α-methylstyrene dimers and/or compounds which form a pentadienyl or 1-phenylallyl radical on abstraction of a hydrogen atom.

22. A polymer latex according to claim 15, wherein the regulator I) is terpinolene.

23. A polymer latex according to claim 15, wherein the regulator II) is a compound having a mercapto group (SH group).

24. A polymer latex according to claim 15, wherein the regulator I) is preferably from 0.01 to 5 parts by weight of monomers; and regulator II) is 2 to 5 parts by weight of monomers.

25. A polymer latex according to claim 15, wherein the polymer is synthesized with the presence of at least one reactive surfactant.

26. A polymer latex according to claim 15, wherein the polymer is synthesized with the presence of a combination of at least one reactive surfactant and non-reactive surfactant.

27. A method for making a polymer latex according to claim 15, wherein the polymer latex is synthesized with a step feeding process.

28. A binder for paper coatings, wherein the binder contains a polymer latex according to claim 15.
